(19) United States
(12) Patent Application Publication
(10) Pub. No.: US 2009/0026783 A1
(43) Pub. Date: Jan. 29, 2009

(54) STORABLE TRUCK RACK SYSTEM

(76) Inventor: Armen Shagbazyan, Glendale, CA (US)

Correspondence Address: Lauson & Tarver LLP, 880 Apollo Street, SUITE 301, El Segundo, CA, 90245, US

(21) Appl. No.: 11/746,822

(22) Filed: May 10, 2007

(51) Int. Cl. B60R 9/00

(52) U.S. Cl. 296/3; 224/402

(57) ABSTRACT

A truck rack system comprising at least two T-bars, a means for storing the T-bars and a means for connecting the T-bars to the truck at different locations and at different positions to create a rack and to facilitate towing. The means for storing the T-bars comprises a pair of sleeves for each T-bar attached to the bottom of the truck on left and right sides. The elongate portion of the T-bar is tightly received in the pair of sleeves for storing. The means for connecting the T-bar to create the rack comprises holes on front and rear bumpers of the truck for connecting the T-bars vertically. The means for connecting the T-bar to facilitate towing comprises at least two hooks and a tow hitch hole on the T-bar and at least two holes on front and rear

### CROSS-REFERENCE TO RELATED APPPLICATION

None

### FEDERALLY SPONSORED RESEARCH

Not Applicable

### SEQUENCE LISTING OR PROGRAM

Not Applicable

### STATEMENT REGARDING COPYRIGHTED MATERIAL

Portions of the disclosure of this patent document contain material that is subject to copyright protection. The copyright owner has no objection to the facsimile reproduction by anyone of the patent document or the patent disclosure as it appears in the Patent and Trademark Office file or records, but otherwise reserves all copyright rights whatsoever.

### BACKGROUND

The present invention relates in general to truck rack systems, and more particularly to a storable truck rack system which can also be used for towing.

Several truck rack systems have been developed in art. For example, U.S. Pat. No. 5,108,141 to Anderson discloses a demountable rack for trucks with canopies, comprising a plurality of vertical support members and horizontal members readily assembled and secured on a pick-up truck bed or the like, with or without a canopy on the truck bed, forming a load-supporting rack outside the space typically occupied by a conventional pick-up canopy. Adjustable members provide for height adjustment and for adaptation of the load mounting area to match the dimensions of the load. Rack support members are inserted vertically into base members that are rigidly mounted in typical stake holes characteristically provided on the rim of a truck bed, obviating the need to weld to the truck or to drill bolt holes in the truck. The base apertures for receiving the vertical support members extend from the rim of the truck bed outside the dimension of a typical truck canopy. The rack is also specifically designed for facile assembly and disassembly.

U.S. Pat. No. 6,513,849 to Carter discloses a modular truck rack formed from a plurality of standardized preformed parts which are used along with several other parts that can be made in varying extensions, permits the interchange of the components in every rack, and the replacement of certain others to size up or size down the same rack to fit any size truck of the same type such as a pickup. An easily removable rear bar permits the truck bed of a pickup truck to carry tall upright items such as a refrigerator without the necessity of dismantling the rack other than the removal of the rear bar.

U.S. Pat. No. 4,509,787 to Knaack discloses a rack for use with a truck having a body. The rack includes upright legs each having a lower end constructed to be mounted to the truck body to define longitudinally spaced pairs of upright legs at transversely opposite sides of the truck. Each leg has an upper end portion. A pair of elongated side members is provided, one side member being clamped to the legs at one side of the truck and the other side member being clamped to the legs at the other side of the truck at longitudinally spaced portions of the side members. Transverse rack members are provided having ends carried on the upper ends of the upright legs. The ends of the transverse members are received in sockets secured to the upper leg ends. A portion of the clamp structure is fixed to the upper leg ends.

Although above truck racks serve the same purpose, the installing procedure and storing means in the present invention are different. In addition, the truck rack system of the present invention can also be used for towing.

### SUMMARY

The present invention is a truck rack system which comprises two T bars, two storing elements secured under the truck on left and right sides, two hooks and a hole on the T-bar. The T-bar comprises a side bar and an elongate bar extending perpendicularly from the side bar. Each storing element includes two holes or sleeves next to each other. The sleeves of the left and right side storing elements are coaxial. In order to store a T-bar, the elongate bar is made to pass through a pair of coaxial sleeves of the left and right side storing elements. In accordance with the present invention, the front and rear bumpers are provided with a rectangular hole and two holes on either sides of the rectangular hole. The rectangular holes receive the elongate bars for securing the T-bars in vertical position. The hooks are on the side bar and can be engaged with the holes on the front and rear bumpers. The free end of the elongate bar includes a hole for connection to tow hitch of another vehicle.

### BRIEF DESCRIPTION OF THE FIGURES

FIG. 1 is a perspective view of the T-bar in accordance with the present invention.

FIG. 2 is a perspective view of the storing element.

FIG. 3 is a front perspective view of the truck, with the front bumper having holes in accordance with the present invention.

FIG. 4 is a rear perspective view of the truck, with the rear bumper having holes in accordance with the present invention.

FIG. 5 is a rear perspective view of the truck with a rack formed by the T-bars.

FIG. 6 is a front perspective view of the truck showing the T-bar hooks engaged to the front bumper of the truck.

FIG. 7 is a rear perspective view of the truck showing the T-bar hooks engaged to the rear bumper of the truck.

### FIGURES—REFERENCE NUMERALS

12 . . . Storing Element
14 . . . Hook
16 . . . Hole on Bar
18 . . . Hole on Bumper
20 . . . Truck
22 . . . Side Bar
24 . . . Elongate Bar
26 . . . Rectangular Plate
28 . . . Sleeve
30 . . . Front Bumper
32 . . . Rear Bumper
34 . . . Rectangular Hole

### DETAILED DESCRIPTION

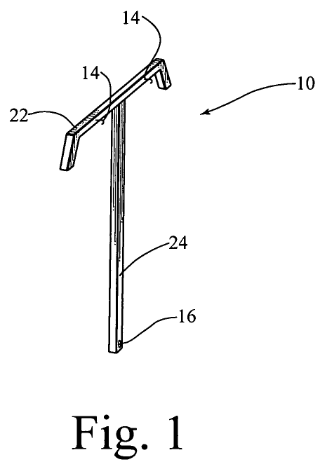

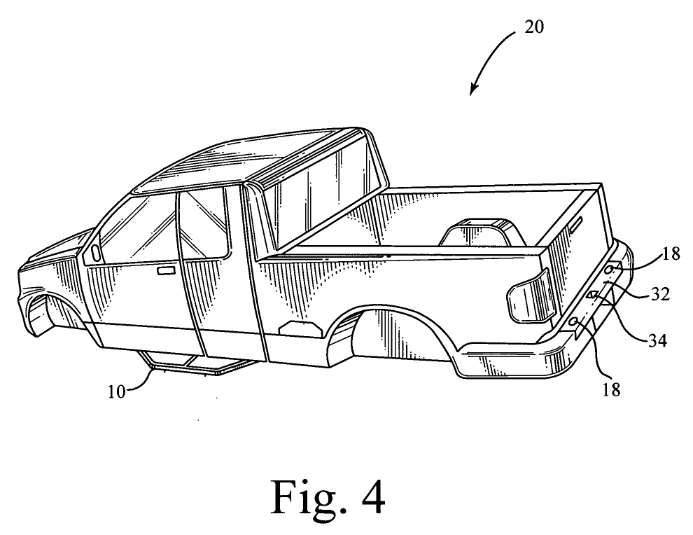

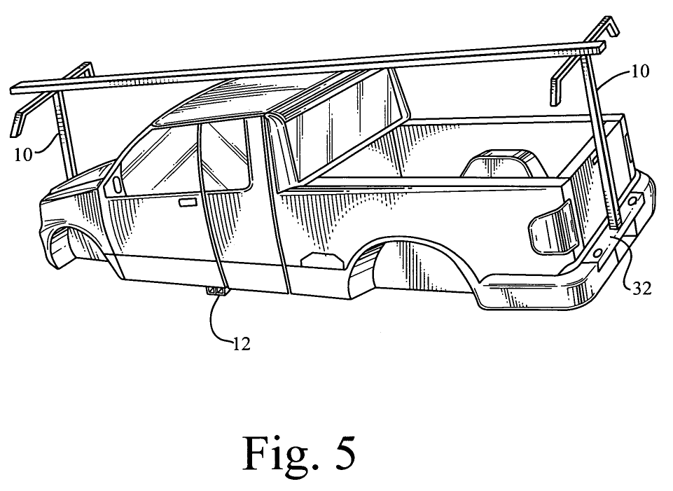

Referring to the drawings, a preferred embodiment of a truck rack system is illustrated in FIGS. 1 through 7. The storable truck rack system comprises two T-bars 10, two storing elements 12, two hooks 14 and a hole 16 on each T-bar and holes 18 on the front and rear bumpers of the truck 20.

Referring to FIG. 1, the T-bar 10 comprises a side bar 22 and an elongate bar 24 extending perpendicularly from the side bar. The side and elongate bars are of rectangular cross section. The side bar 22 includes two hooks 14 welded or bolted to it and the elongate bar 24 has a hole 16 at its free end.

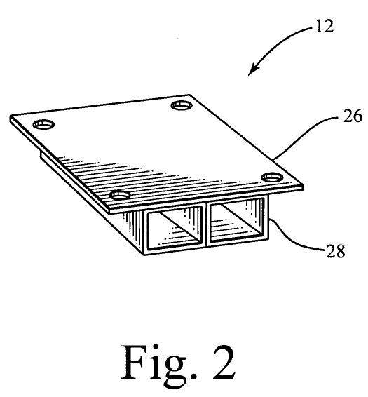

Referring to FIG. 2, the storing element 12 comprises a rectangular plate 26 with four bolt holes and two sleeves 28 of rectangular cross section mounted next to each other on the rectangular plate 26. The elongate bar fits tightly in a sleeve 28. The two storing elements 12 are mounted underneath the truck 20 on left and right sides with bolts such that their sleeves are coaxial.

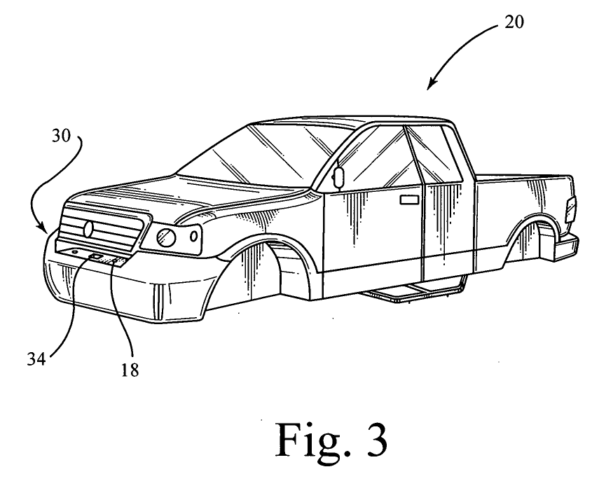

Referring to FIGS. 3 through 5, in accordance with the present invention, the front 30 and rear 32 bumpers of the truck 20 are provided with a rectangular hole 34 and two holes 18 on either sides of the rectangular hole. The rectangular hole is adapted to tightly receive the free end of an elongate bar. The two T-bars 10 are secured vertically to form a rack by inserting their elongate bars 24 in the rectangular holes 34 of the front 30 and rear bumpers 32. A lumber can then be placed on the side bars 22. In order to store a T-bar 10, its elongate member 24 is inserted in a sleeve 28 of the left side storing element and pushed such that its free end is received in a coaxial sleeve of the right side storing element. Similarly, the elongate member 24 of another T-bar is inserted in the coaxial sleeves of the left and right side sleeves from the right side of the truck.

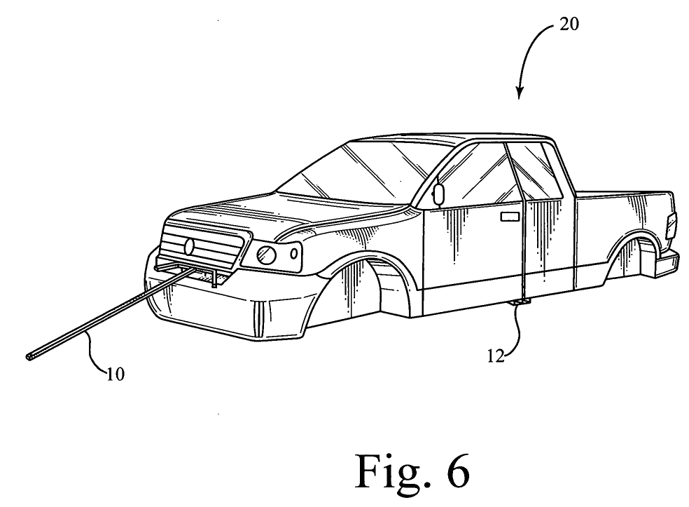

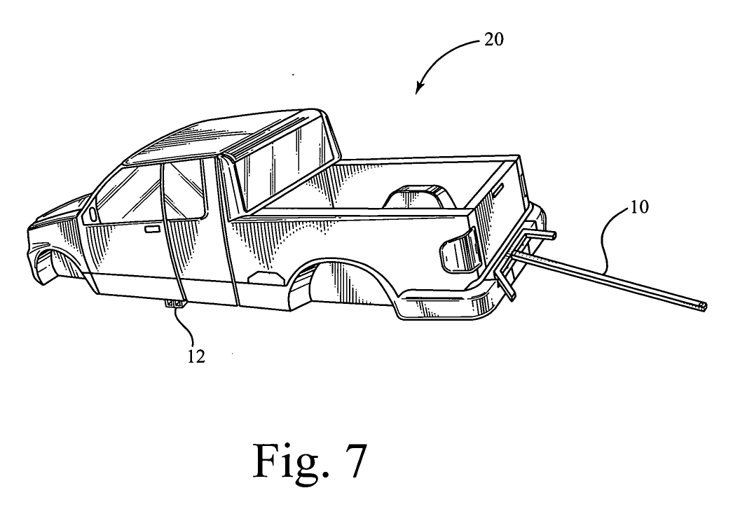

Referring to FIGS. 6 and 7, the hooks 14 on the side bar 22 are engaged with the holes 18 on the front bumper 30 and tow hitch of another vehicle is connected to the hole 16 on the elongate bar for towing the truck 20. In order to tow a vehicle, the hooks 14 are engaged with the holes 18 on the rear bumper 32 and the hole 16 on the elongate bar is used for connection with the vehicle's tow hitch.

All features disclosed in this specification, including any accompanying claims, abstract, and drawings, may be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means for” performing a specified function, or “step for” performing a specific function, is not to be interpreted as a “means” or “step” clause as specified in 35 U.S.C. § 112, paragraph 6. In particular, the use of “step of” in the claims herein is not intended to invoke the provisions of 35 U.S.C. § 112, paragraph 6.

Although preferred embodiments of the present invention have been shown and described, various modifications and substitutions may be made thereto without departing from the spirit and scope of the invention. Accordingly, it is to be understood that the present invention has been described by way of illustration and not limitation.

What is claimed is:

1. A truck rack system, comprising:
(a) a means for storing at least two T-bars, each of the T-bars comprising a side bar and an elongate bar extending perpendicularly from the side bar;
(b) a means for connecting the at least two T-bars to a truck at different locations and at different positions to create a rack and to facilitate towing.

2. The system of claim 1, wherein the means for storing the T-bars comprises a sleeve for each T-bar underneath the truck.

3. The system of claim 2, the sleeve extends along the width of the truck and is adapted to tightly receive the elongate bar of the T-bar.

4. The system of claim 1, wherein the means for storing the T-bars comprises a pair of sleeves for each T-bar attached to the bottom of the truck, with one of the sleeves on the left side of the truck and the other on the right side.

5. The system of claim 4, wherein the elongate bar of the T-bar is tightly received in the pair of sleeves.

6. The system of claim 1, wherein the means for connecting the T-bar for creating the rack comprises a hole on the truck for each T-bar, the hole being adapted to receive the distal end of the elongate bar so as to secure the T-bar vertically.

7. The system of claim 6, wherein the front and rear bumpers of the truck are provided with the hole.

8. The system of claim 1, wherein the means for connecting the T-bar to facilitate towing comprises at least two hooks on the side bar of the T-bar, at least two holes on the truck for engaging the at least two hooks and a tow hitch hole at the free end of the elongate bar.

9. The system of claim 8, wherein the front and rear bumpers of the truck are provided with the holes, the hooks are engaged with the holes on the front bumper and tow hitch of another vehicle is connected to the tow hitch hole for towing the truck, and the hooks are engaged with the holes on the rear bumper and tow hitch of another vehicle is connected to the tow hitch hole for towing the vehicle.
